(19) United States
(12) Patent Application Publication
(10) Pub. No.: US 2020/0073920 A1
(43) Pub. Date: Mar. 5, 2020

(54) SYSTEMS AND METHODS FOR REMOTE DASHBOARD IMAGE GENERATION

(71) Applicant: Dundas Data Visualization, Inc., Toronto (CA)

(72) Inventor: Eugen Dan Ciloci, Toronto (CA)

(21) Appl. No.: 16/508,867

(22) Filed: Jul. 11, 2019

Related U.S. Application Data
(63) Continuation of application No. 15/133,482, filed on Apr. 20, 2016, now abandoned.
Application No. 15/133,482 is a continuation of application No. 13/368,441, filed on Feb. 8, 2012, now abandoned.
(60) Provisional application No. 61/481,391, filed on May 2, 2011.

(51) Int. Cl. G06F 17/22; G06Q 10/06; G06F 3/0488; G06F 3/0482; G06F 16/958; G06F 16/248; G06F 16/25; G06Q 10/10

(52) U.S. Cl. CPC G06F 17/2247; G06Q 10/06393; G06F 17/227; G06F 3/0488; G06Q 10/10; G06F 16/958; G06F 16/248; G06F 16/252; G06F 16/25; G06F 3/0482

(57) ABSTRACT

Systems and methods for generating a dashboard for access on a remote computing device. Systems may include a business database storing a plurality of business values; a dashboard generator; an image converter and a web page generator. The dashboard generator may derive a plurality of key performance indicator values from the database and generate first dashboard image data. The image converter may generate second dashboard image data corresponding to the first dashboard image data. The web page generator may generate a web page comprising the second dashboard image data. Methods may include: receiving a dashboard generation request from the remote computing device; deriving a plurality of key performance indicator values from a business database; determining first dashboard image data corresponding to the key performance indicator values; determining second dashboard image data corresponding to the first dashboard image data; and generating a dashboard web page comprising the second dashboard image data.

### CROSS-REFERENCE TO RELATED APPLICATIONS

This application is a continuation of U.S. patent application Ser. No. 15/133,482 filed Apr. 20, 2016, which is a continuation of U.S. patent application Ser. No. 13/368,441 filed Feb. 8, 2012, which claims the benefit of U.S. provisional patent application No. 61/481,391 filed May 2, 2011. The entire content of each of U.S. patent application Ser. Nos. 15/133,482 and 13/368,441, and U.S. provisional patent application No. 61/481,391 is hereby incorporated by reference.

### TECHNICAL FIELD

The described embodiments relate generally to the creation and distribution of dashboards, with common but by no means exclusive application to the display of such images on mobile communication devices or other computer devices operatively coupled to the Internet.

### BACKGROUND

“Dashboards” present visualizations, for example, in graph or chart form, of key performance indicator (KPI) values, metric values, or information derived from business values or data stored in business databases. Such visualizations may be viewed (e.g., on a computer screen or other display device) by executives to obtain an overview of how a business is performing.

The inventors have recognized that it may be desirable to be able to view dashboard information on a computing device that is remote or otherwise separate from the server or system creating the dashboard. Such remote computing device may not have a software graphics platform.

Additionally, client devices such as smartphones may support only touch events natively. However, most websites have no concept of touch events and are designed to respond to mouse events only. Thus, web browsers on touch devices generally implement a compatibility/legacy layer that emulates mouse events by generating corresponding, emulated (fake) mouse events. This approach allows new touch devices to work with existing websites, but results in a delay/lag and other potential disadvantages.

The inventors have recognized a need for improved systems and methods for generating and displaying dashboards remotely. The embodiments described herein may address in whole or in part some or all of the above-noted challenges.

### BRIEF DESCRIPTION OF THE DRAWINGS

Embodiments are described in further detail below, by way of example only, with reference to the accompanying drawings, in which:

FIG. 1 is a schematic diagram of one implementation of a system for generating a dashboard for access on a remote computing device, in accordance with the present disclosure.

FIG. 2 is a schematic illustration of an exemplary dashboard, as may be generated in accordance with the present disclosure.

FIG. 3 is a schematic illustration of the internal components of the image converter of FIG. 1 shown in greater detail, in accordance with the present disclosure.

FIG. 4 is a flowchart illustrating the steps in a method for generating a dashboard for access on a remote computing device, in accordance with the present disclosure.

FIG. 5 is a schematic illustration of the process implemented by the WPF-to-SVG converter of FIG. 3, in accordance with the present disclosure.

FIGS. 6A-6C are charts containing exemplary data illustrating the conversion of an ellipse object (as may be stored in a graphics platform format) into a converted second format for incorporation into and display in the dashboard web page, in accordance with the present disclosure.

FIG. 7 is a schematic diagram providing additional detail of the dashboard generator and image converter of FIG. 1 and their interaction with other components of the system 100 as may be implemented in accordance with the present disclosure.

FIG. 8 is a flowchart illustrating the steps in a method for generating a dashboard for access on a remote computing device, in accordance with one or more possible embodiments.

FIG. 9, illustrated therein is a schematic diagram providing additional detail of the content of the converted data representing a dashboard.

FIG. 10 is a schematic diagram providing additional detail of the JavaScript framework of FIG. 9.

FIG. 11 is a flowchart illustrating the steps in a method for generating a dashboard for access on a remote computing device, in accordance with one or more possible embodiments.

### DETAILED DESCRIPTION

The embodiments described below relate generally to a dashboard creation and management system that lets users view data visualization dashboards. Dashboards may display graphical elements that contain visual representations of key performance indicators or metrics for a business. KPIs may be business metrics that assist a business to better understand the data it has collected relating to the operation of the business. By way of example only, a dashboard created for a retail business might illustrate in graph form the business' retail sales over a period of time. Such exemplary dashboard might also illustrate in a pie chart the retail sales by product category (eg. clothing, shoes, sporting equipment) over the same (or a different) period of time. As will be understood, the nature of the KPIs or metrics displayed will vary based on the nature of the business and the needs of the individual wishing to view and understand different business metrics.

For the purposes of the present disclosure such a dashboard creation and management system may typically include two types of dashboard viewing users (who are often business executives): those who are able to locally view and interact with a dashboard using a computer directly coupled to the dashboard generation system or network (ie. not via the internet) (referred to generally below as “local viewers”), and those who are able to view and interact with a dashboard using a remote computer (ie. via the internet) (referred to below generally as “remote viewers”).

Dashboards may be designed to be interactive in a number of different ways. For example, an interactive viewer may be able to configure the date ranges to be used for filtering the business data which is to be represented in the KPIs on the dashboard. Some dashboards may be configured to allow different categories of business data to be represented in the KPIs, such as product types sold or sales by selected stores. Any particular dashboard may provide a variety of interaction options appropriate for the application.

As will be understood, the software required to interact with a dashboard (which would typically be installed on a business' office computers) may not be available on all computing devices to which an executive has access (for example, a smartphone, a tablet, or a personal computer which has not been configured with the necessary software). While away from the fully configured computers available at a business' office, an executive may still desire to view and interact with a dashboard.

In order to “render” or display dashboards, the device or computer typically requires a specific graphics or user interface platform or sub-system to be installed or supported (e.g., Adobe Flash, Microsoft Silverlight, Microsoft Windows Presentation Foundation (WPF)). However, such graphics platforms may only be available for a small number of device types. For example, most mobile devices (e.g., smartphones and tablets) do not support Silverlight or WPF. This limitation prevents dashboards from being viewed or interacted with on most mobile devices.

A typical dashboard is rendered using a combination of generalized graphical controls (e.g., labels, rectangles, buttons) and more specialized graphical controls geared towards data visualization (e.g., charts, gauges, maps, data grids). These graphical controls may depend on graphics platforms (e.g., Silverlight, WPF) that provide support for user interaction and vector graphics, which allows the rendering of controls to scale well at different display or print resolutions. While the majority of mobile devices such as smartphones and tablets may not support such graphics platforms, they do in general provide built-in support for other web browser standards or formats such as HTML/HTMLS (HyperText Markup Language), CSS (Cascading Style Sheets), JavaScript, SVG (Scalable Vector Graphics) and bitmapped images. In combination, these and other web standards may allow interactive and scalable graphics to be rendered by the web browser of a mobile device.

One aspect of the technology described herein relates to a method for generating a dashboard for access on a remote computing device. The method may include: receiving a dashboard generation request from the remote computing device; deriving a plurality of key performance indicator and/or metric values from a business database; determining first dashboard image data corresponding to the key performance indicator and/or metric values; determining second dashboard image data corresponding to the first dashboard image data; and generating a dashboard web page comprising the second dashboard image data.

In some implementations, the dashboard web page may be accessed by the remote computing device. As well, the dashboard generation request may be communicated via the Internet. In some instances, the dashboard generation request corresponds to a dashboard URL. In turn, the dashboard web page may also correspond to or be accessed via the dashboard URL.

The method may also include communicating a message corresponding to the dashboard generation request to the remote computing device. The message may be communicated via the Internet. In addition or in the alternative, the message may include a dashboard URL or other storage address.

As well, in some implementations, the dashboard generation request comprises at least one parameter and the first dashboard image data corresponds to the at least one parameter.

In some instances, the first dashboard image data corresponds to a graphics platform. By way of example, the graphics platform may be Microsoft Silverlight or WPF.

Additionally, the first dashboard image data may comprise at least one graphical object.

In some implementations, the second dashboard image data corresponds to a web browser format. For example, the web browser format may be HTML/HTMLS, CSS, JavaScript or SVG. A combination of these formats may also be used.

One aspect of the technology described herein relates to a system for generating a dashboard for access on a remote computing device. The system may include a business database storing a plurality of business values; a dashboard generator; an image converter and a web page generator. The dashboard generator may be configured to derive a plurality of key performance indicator and/or metric values from the business database and generate first dashboard image data corresponding to the plurality of key performance indicator/metric values. The image converter may be operatively coupled to the dashboard generator and configured to generate second dashboard image data corresponding to the first dashboard image data. As well, the web page generator may be operatively coupled to the image converter and configured to generate a web page comprising the second dashboard image data.

In some implementations, the web page generator may be operatively coupled to the dashboard generator. Alternatively, the web page generator may form part of the dashboard generator. Similarly, in some implementations, the image converter may comprise part of the dashboard generator. The web page may be configured to receive a dashboard generation request from the remote computing device. Such a dashboard generation request may be communicated via the Internet. Sometimes, the dashboard generation request corresponds to a URL. The dashboard web page may correspond to the URL. For some configurations, the dashboard generation request includes at least one parameter and the dashboard image corresponds to the at least one parameter.

In some implementations, the dashboard generator is configured to communicate a message corresponding to the dashboard generation request to the remote computing device. The message may be communicated via the Internet.

As well, in some implementations, the dashboard generation request comprises at least one parameter and the first dashboard image data corresponds to the at least one parameter.

In some instances, the first dashboard image data corresponds to a graphics platform. By way of example, the graphics platform may be Microsoft Silverlight or WPF.

Additionally, the first dashboard image data may comprise at least one graphical object.

In some implementations, the second dashboard image data corresponds to a web browser format. For example, the web browser format may be HTML/HTML5, CSS, JavaScript or SVG or some combination thereof.

A further aspect of the technology described herein relates to a method for determining whether a browser is configured for touch events or mouse events. The method may include: accessing a web page via the browser; receiving from the web page at least one control (which may be a JavaScript control), wherein the control is configured to hook either a mouse event or a touch event; registering a callback for the control with a script manager; upon detecting a first event, determining the type of the first event, wherein the type corresponds to a mouse event or a touch event; and determining the configuration of the browser corresponding to the type. In some implementations, the method may further include: upon determining the type of the first event, registering the control corresponding to the type. For clarity, the control is only registered to one of a mouse event type and a touch event type, but not both.

Another aspect of the technology described herein relates to a system for determining whether a browser is configured for touch events or mouse events. The system may include a web page having at least one control (which may be a JavaScript control), together with a script manager. The control is configured to hook either a mouse event or a touch event. As well, the JavaScript control is configured to register a callback with the script manager. The script manager is configured to determine the type of a first event, wherein the type is either a mouse event or a touch event. Upon determining the type of the first event, the script manager is configured to register the control corresponding to the type. For clarity, the control is only registered to one of a mouse event type and a touch event type, but not both.

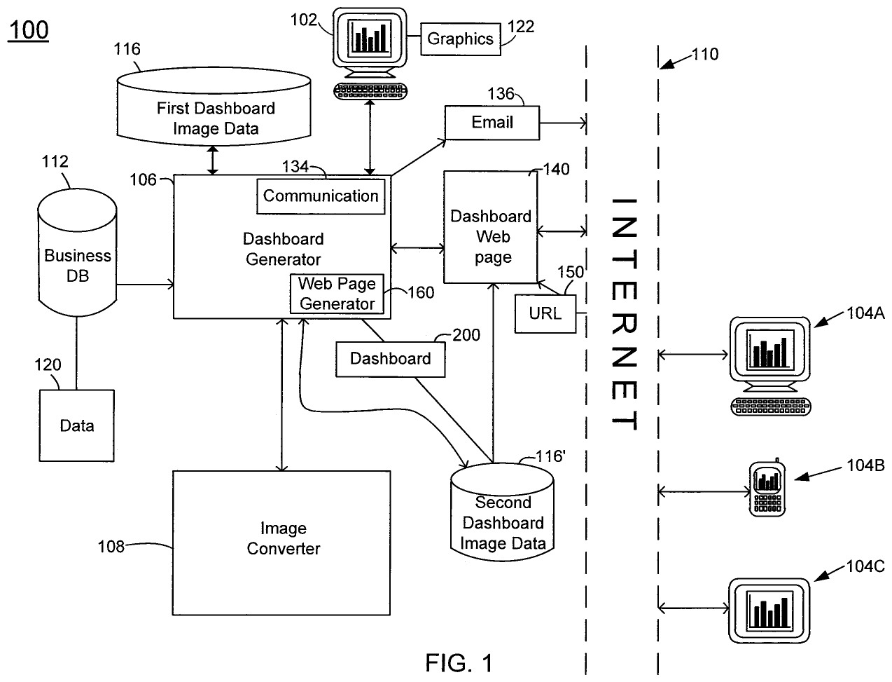

Referring to FIG. 1, illustrated there is a block diagram of one possible embodiment of a system for generating a dashboard for access (on a remote computing device), shown generally as 100. The system 100 may include one or more fully enabled client terminals 102, one or more remote terminals or computing devices 104A, 104B, 104C, a server-side dashboard generator module 106 and an image converter 108. Each of these components may be networked (in addition to being coupled to the Internet 110) and be operable to communicate with each other. While connectivity is described herein throughout in relation to the Internet 110, it should be understood that other types of networks, such as a local area network (LAN) may be used. Without intending to be limiting, the remote computing devices may, for example, be in the form of a personal computer 104A, a smartphone 140B, or a tablet 104C configured with a web browser. For example, such browsers may be HTML5 and SVG-compliant. As will be understood, dashboards prepared in accordance with the present embodiment for display on such browsers may be scalable with the use of SVG graphics, and may also be interactive through the use of JavaScript (JS). The remote computing devices 104A, 104B, 104C will also typically be configured with an email reader.

Further, while the generator module 106 and image converter 108 are illustrated as being separate components, it should be understood that in some implementations, the image converter 108 may be considered to comprise part of the dashboard generator module 106 and/or reside on the same server/computer. In some implementations, the converter 108 may be an in-memory converter or exporter that transforms Silverlight or WPF graphical objects to SVG graphical objects, for example. Briefly, as will be understood, rendering of dashboard controls may be performed on the server/computer on which the dashboard generator 106 resides, and then such controls may be converted to more accessible web standard formats such as HTML5 and SVG which may be viewed on a remote computer via a suitably configured web browser. Complex data visualization controls such as charts may be rendered via a WPF-to-SVG converter. This avoids the need to re-implement such controls natively in HTML/HTML5/SVG/JavaScript/CSS and enables re-use of the code written for the original Silverlight version of the dashboard. The conversion may be performed on-demand and may be dynamic in order to handle changes made to the dashboard controls via script interactions with the browser.

The system 100 may also include a business database 112. A business data server (not shown) may also be provided which executes software components that provide access to the business database 112.

As will be discussed in greater detail below, the business database 112 may store business data 120 corresponding to a plurality of business values (e.g., sales, expenses, inventory or human resources data) that relate to the operation of a business. As an illustration, the business database 112 may be an accounting and inventory management database that stores transactional data for a sporting goods store. In some embodiments, the business database 112 may be stored on a separate computer or server accessible by the dashboard generator 106.

As will be understood, all or a subset of business values may be selected from the business database 112 for the purpose of deriving (or calculating) KPI or metric values for visualization on the dashboard to be generated. For example, the KPI/metric values may be derived by performing a summation or other mathematical process on the business values.

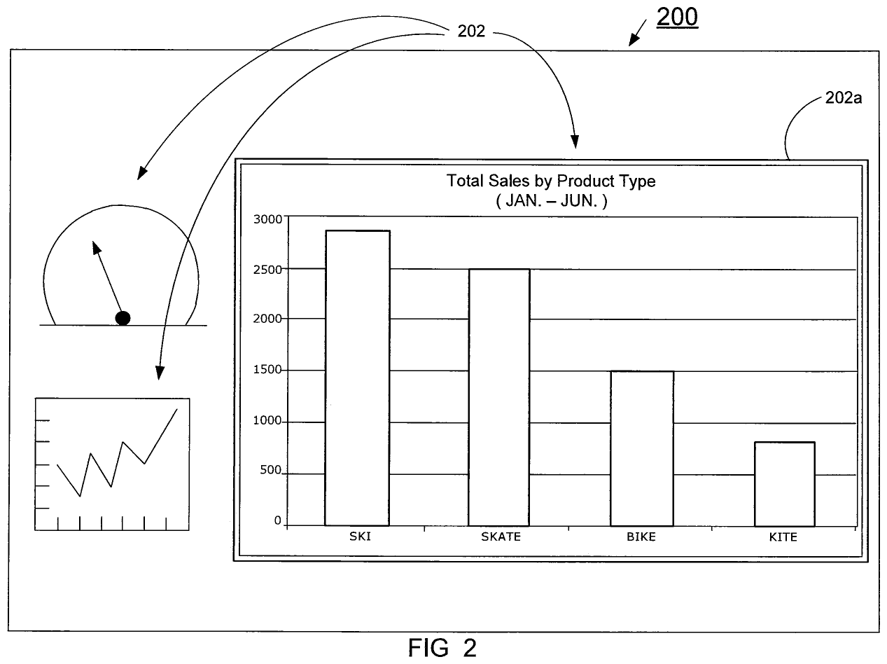

Referring briefly to FIG. 2, shown there is an example dashboard 200 showing various different graphical KPI visualizations 202. One exemplary type of KPI visualization illustrated in the dashboard 200 is the ‘Total Sales by Product Type’ KPI 202a, depicting bar graph data corresponding to sales of specified products over a period of time.

Referring again to FIG. 1, exemplary client terminals 102, remote computing devices 104A, 104B, 104C, dashboard generator module 106 and image generator 108 may comprise a number of components (which have not all been illustrated), including microprocessors. In the exemplary configuration illustrated in FIG. 1, the microprocessor (which may be in the form of a server, for example) on which the software of the image generator 108 is run is referred to herein as the image creating computer 114. As noted above, this microprocessor 114 may be the same as or different from the microprocessor(s) (which may be in the form of one or more servers, for example) on which the software of the dashboard generator module 106 runs.

Microprocessors typically control the overall operation of computer systems. Microprocessors interact with additional subcomponents such as memory storage (which may include random access memory (RAM) and read-only memory (ROM), and persistent storage such as flash memory), display, network adapter and input device(s), for example, such as a keyboard, mouse, touchscreen (which may form part of the display) or touchpad. Network adapters allow connection to different types of networks (for example, Local Area Networks (LANs) as well as Wide Area Networks (WANs)), and may be wired (for example, through an Ethernet connection) or wireless (for example, through 802.11 Wireless Local Area Network (WLAN) or cellular standards). Operating system software used by a microprocessor is typically stored in a persistent store such as flash memory or read-only memory (ROM) or similar storage. Those skilled in the art will appreciate that the operating system, specific software components, or parts thereof, may be temporarily loaded into a volatile store such as RAM. Microprocessors, in addition to operating system functions, enable execution of software components.

In the exemplary embodiment in FIG. 1, it should be understood that the computers/microprocessors of the remote terminals or computing devices 104A, 104B, 104C are separate from the image generating computer 114. Reference herein to “remote” computing devices 104A, 104B, 104C is intended to convey that such computing devices 104A, 104B, 104C are remote from the dashboard generator 106 and indirectly coupled thereto via the Internet 110—in this context, “remote” is not intended to refer to geographical distance. Such remote computing devices 104A, 104B, 104C do not have graphical platforms installed, capable of recognizing and using the first dashboard data 116, as will be discussed in greater detail below.

From a high level perspective, the dashboard generation module 106 provides interactive dashboard functionality and visualization for interactive viewers on the fully graphics-enabled client terminal 102. While not illustrated, it will be understood that more than one client terminals 102 may access (simultaneously or otherwise) the interactive dashboard functionality provided by dashboard generation module 106. The dashboard generation module 106 may generate first dashboard image data 116 which consists of data needed to render the desired dashboard on the client terminal 102. This image data 116 may contain serialized definitions of dashboards and Silverlight or WPF-based graphical controls.

In contrast, users may be able to view and interact with a dashboard (such as dashboard 200) on the remote computing device(s) 104A, 104B, 104C via a web page. The dashboard URL (uniform resource locator) 150 address corresponding to the dashboard web page 140 is communicated to the remote computing device(s) 104A, 104B, 104C typically via the Internet, such as via email. As will be discussed in greater detail, below, the dashboard image data 116′ is generated by the image converter 108 upon request from the dashboard generation module 106. The image converter 108 may transform, export or otherwise convert the first dashboard image data 116 to standard formats (eg. HTML/HTML5, SVG, CSS, JavaScript, bitmapped images) to generate the second dashboard image data 116′. Such second dashboard image data 116′ may be recognized and understood by a majority of web browsers on a wide range of device types.

As noted above, the business database 112 may store business data 120. Such business data 120 may correspond to any data stored by a business organization in relation to the operation of its business. For example, this may include transactional sales data or inventory data. The dashboard generation module 106 may include a dashboard creation and management system for creating and managing executive business dashboards (such as exemplary dashboard 200 illustrated in FIG. 2) that show business metrics, typically in a graphical format. As noted above, such business metrics for the dashboard creation and management system may be derived from the business data 120.

Dashboard generation module 106 may select certain business data 120, generate corresponding KPIs/metrics and organize/present the KPIs/metrics in a dashboard 200 for interactive viewing by business executives using a client terminal 102 (for example, which may be in the form of a desktop or notebook PC). Such terminal 102 may be equipped with a graphics platform 122 such as Microsoft® Silverlight™ or Windows Presentation Foundation™ (WPF). Specifically, the user may use a desktop software application (e.g., equipped with WPF) or a web browser (e.g., equipped with Silverlight™) available on terminal 102 to select and interactively view a dashboard 200 of interest.

A request to view a dashboard 200 may be made from the terminal 102 to the dashboard generation module 106. The dashboard generator 106 returns data 116 which consists of information needed by the graphics platform 122 to render the desired dashboard 200 on the display of computer 102. In this way, the client terminal 102 may be considered a client computer in the client-server software architecture known in the art.

As will be understood, the dashboard generation module 106 may further be configured to request that the image converter 108 convert image data for a specified dashboard 200. By “specified”, it is meant that various parameters defining the type of data and the display preferences of the dashboard are determined by the dashboard generation module 106 (often as a result of input from the user of the terminal 102). As will be understood in the context of the following discussion, the dashboard generation module 106 may be configured to create a dashboard URL 150 corresponding to the desired dashboard 200 and its preferences.

Referring again briefly to FIG. 2, by way of example only, preferences determined for the dashboard 200 may include the products to be included in the “Total Sales by Product Type” KPI 202a (eg. “Ski”, “Skate”, “Bike”, “Kite”), the date range of the data to be displayed (January to June), as well as the choice to illustrate the data in a bar graph format. As will be understood, other types of preferences may be determined in order to specify the KPIs or metrics to be determined and displayed, as well as the configuration of the dashboard 200. Once the first dashboard image data 116 corresponding to the dashboard 200 is created, the image converter 108 may generate and return corresponding second dashboard image data 116′ back to the dashboard generator module 106.

Referring again to FIG. 1, the generation module 106 may include a communication module 134 configured to include the dashboard URL 150 corresponding to the desired dashboard 200 in the form of a hyperlink in an email message 136. Such email message 136 may then be communicated to a remote computing device 104A, 104B, 104C.

The dashboard generator 106 may also be provided with a web page generator 160 configured to generate and host an Internet web page 140 that incorporates the generated second dashboard image data 116′ and presents the dashboard 200. As will be understood, in some implementations, the web page generator 160 may be a separate component from the dashboard generator 106. The dashboard web page 140 is accessible to a remote computing device(s) 104A, 104B, 104C which has been configured with a web browser and is coupled to the Internet 110. As noted above, the remote computing device 104A, 104B, 104C may be provided with the dashboard URL 150 from receipt of the email message 136. Once in possession of the dashboard URL 150, as will be understood, a remote computing device 104A, 104B, 104C may access the dashboard web page 140 via the Internet 110.

Typically, the web page 140 would comprise basic HTML coding in addition to the second dashboard image data 116′ and be viewable by a standard web browser—as a result (as previously noted), no specialized graphics platform (similar to the graphics platform 122 the local terminal 102 may be equipped with) which would otherwise be required for viewing the dashboard (using the first dashboard image data 116), is possessed by such remote computing device(s) 104A, 104B, 104C.

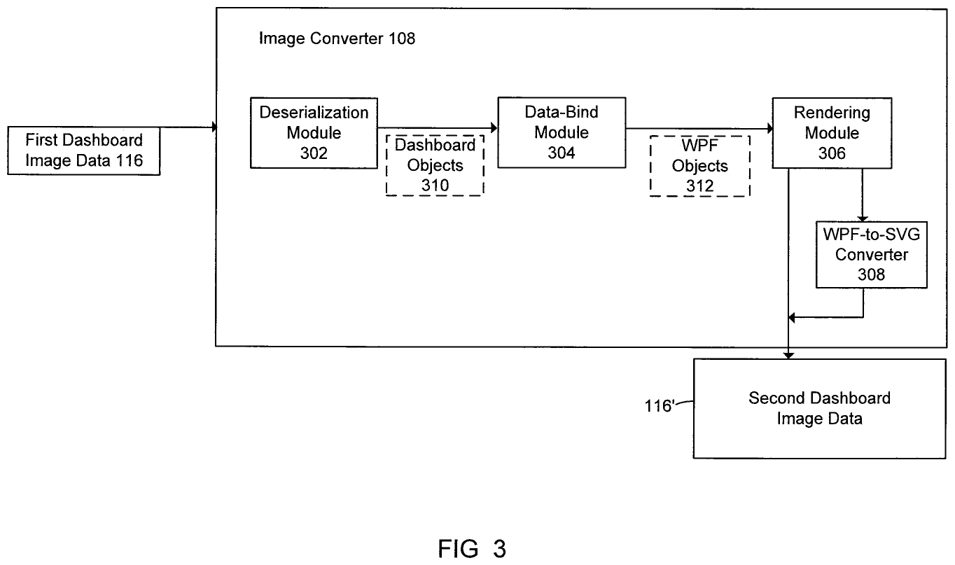

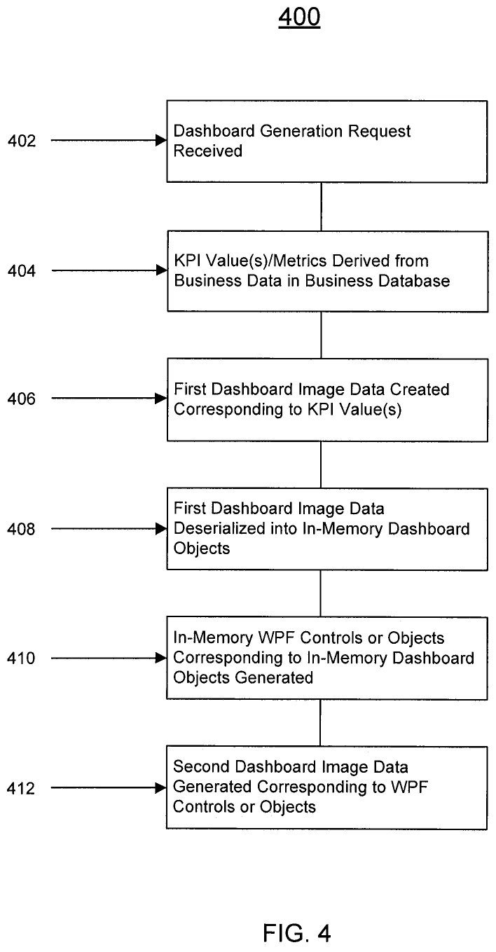

Referring simultaneously to FIGS. 3 and 4, exemplary methodology and component configuration are discussed. FIG. 3 illustrates the internal components of the image converter 108 in greater detail in one embodiment as may be implemented in accordance with the present disclosure. FIG. 4 is a flow diagram of a method, shown generally as 400, for generating a dashboard for access on a remote computing device, in accordance with one or more possible embodiments.

The “on-demand” generation of a dashboard 200 may be initiated by a computer, such as a remote computing device 104A, 104B, 104C navigating to the dashboard image web page 140 (and which may be hosted by, and forms part of, the dashboard generator 106) at the corresponding URL, in order to cause the generation of a specific dashboard request. A dashboard generation request is received by the dashboard generation module 106 from the remote computing device 104A, 104B, 104C accessing the dashboard image web page 140. (Block 402)

As noted above, various parameters defining the type of data and the display preferences of the dashboard 200 may be specified within the dashboard URL 150 corresponding to the dashboard web page 140. Such parameters may be communicated to the generation module 106 via URL query parameters. By way of further example, such parameters may include the information needed to identify the dashboard (such as its GUID (Globally Unique Identifier) and the state of its filters (if any), which are passed in to the web page 140.

Upon receiving the query parameters necessary to identify and/or generate the desired dashboard 200, the dashboard generator 106 is configured to access the business database 112 and derive one or more KPI or metric values from the business data 120. (Block 404)

When the dashboard generator 106 has finished determining or rendering the dashboard 200 (corresponding to the query parameters), it creates first dashboard image data 116 corresponding to the dashboard 200. (Block 406) As will be understood, the first dashboard image data 116 corresponds to or otherwise describes the derived KPI/metric value(s).

Referring specifically to FIG. 3, illustrated therein is a block diagram of one possible configuration of a deployed dashboard converter 108. The first dashboard image data 116 is applied as input to the conversion system 108. As discussed previously, the first dashboard image data 116 includes information needed to render a dashboard 200 on a display-capable device. Such information may include serialized definitions of dashboards, graphical controls or encapsulations of the data being visualized.

A deserialization module 302 deserializes the first dashboard image data 116 into in-memory dashboard objects 310. (Block 408) A data-binding module 304 receives the dashboard objects 310 as input and generates WPF controls or objects 312 which also exist in-memory. (Block 410) The WPF objects 312 define the visual representation of a dashboard 200 which corresponds exactly to the first dashboard image data 116. A rendering module 306 takes the set of WPF objects 312 as input and as described in greater detail below, renders the corresponding dashboard 200 in second dashboard image data 116′ which adheres to web browser standards such as HTML/HTMLS, SVG, CSS, JavaScript and bitmapped image formats. (Block 412)

The rendering module 306 may render the set, or a subset, of the WPF controls or objects 312 in the form of a bitmapped image. This functionality can be described as taking a “snapshot” of the corresponding dashboard or set of controls.

In addition or in the alternative, the rendering module 306 may render certain types of WPF objects 312 (e.g., data visualization controls) in the SVG format, which provides support for vector graphics. In such cases, the rendering module 306 may use a WPF-to-SVG converter 308 to transform, export or otherwise convert WPF objects 312 to SVG objects. The rendering module 306 uses the resulting SVG objects to embed corresponding SVG content (e.g., SVG markup tags) into the second dashboard image data 116′.

As will be understood, certain types of WPF objects which require user interaction, such as input or selection controls, may be rendered as HTML/HTML5 elements rather than as SVG objects since SVG is primarily a presentation or graphics output format. HTML/HTML5 may also be used instead of SVG in cases where, for example, HTML/HTML5 elements exist that match the type of WPF object being converted more naturally.

Additionally, in some instances, the second dashboard image data 116′ may also be generated to include JavaScript. Depending on the type of device 104A, 104B, 104C and web browser, JavaScript may be used to facilitate user interaction with the rendered dashboard 200. For example, JavaScript may be used to provide tooltips on mobile devices because most web browsers on mobile devices 104A, 104B, 104C do not support tooltips natively.

The conversion process or steps described in relation to FIG. 4 may be performed using separate threads (e.g., one thread per dashboard viewing request) in order to avoid performance bottlenecks which may occur when multiple requests to view dashboards are delivered simultaneously to the dashboard conversion system 108.

Silverlight/WPF-to-SVG converter

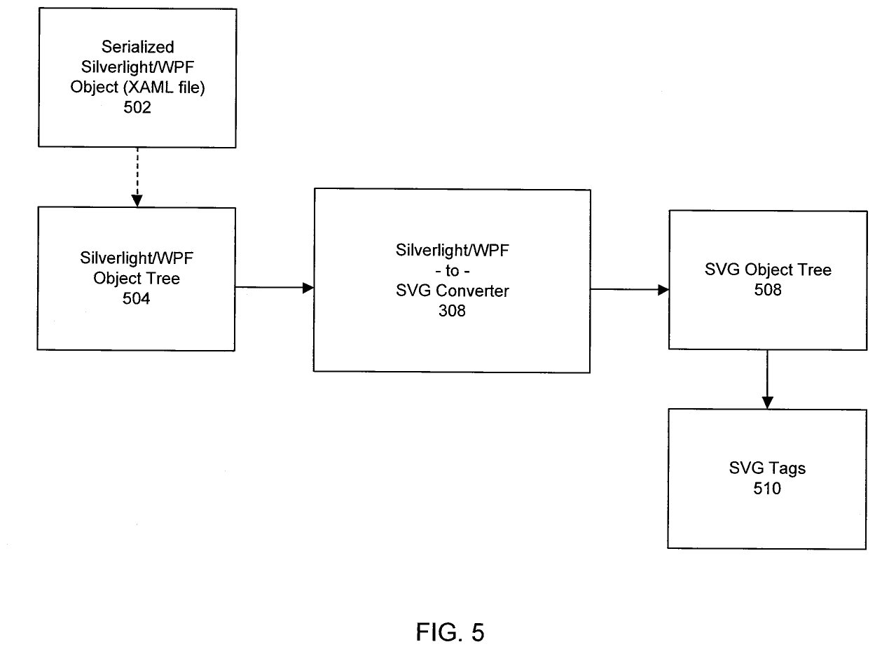

FIG. 5 is a schematic diagram illustrating the operation of the WPF-to-SVG converter 308. FIG. 5 illustrates the process of converting a single WPF control to SVG format. A serialized WPF control object (as may be stored in the first dashboard image data 116) is stored in-memory as a tree of WPF objects 504. For example, a “radial gauge” data visualization control in the WPF format may be represented as a tree of graphical primitive objects such as ellipses, rectangles or other types of geometry. The WPF object tree 504 is passed as input to the WPF-to-SVG converter 308. The converter 308 visits each node or object in the WPF object tree 504 in a specific order and, for each object, creates one or more corresponding SVG objects. These SVG objects are then inserted into a SVG object tree 508, which is the SVG representation of the WPF control 502 being converted.

The SVG object tree 508 may be used to generate or output corresponding SVG markup tags 510, which may be written out in the form of an “SVG file” (e.g., with file extension “.SVG”), or embedded directly into a raw HTML stream for display in a SVG-compliant web browser.

Since Silverlight can be considered in some ways to be a subset of WPF, the converter 308 in FIG. 5 can be easily adapted to the conversion of Silverlight objects instead of WPF.

Optionally, as shown in FIG. 5, a Silverlight or WPF control that is described in a “XAML file” 502, or described in the form of XAML (Extensible Application Markup Language) markup, can be deserialized into memory as a Silverlight/WPF object tree 504 and then applied as input to the converter 308.

Example conversion of a Silverlight or WPF ellipse

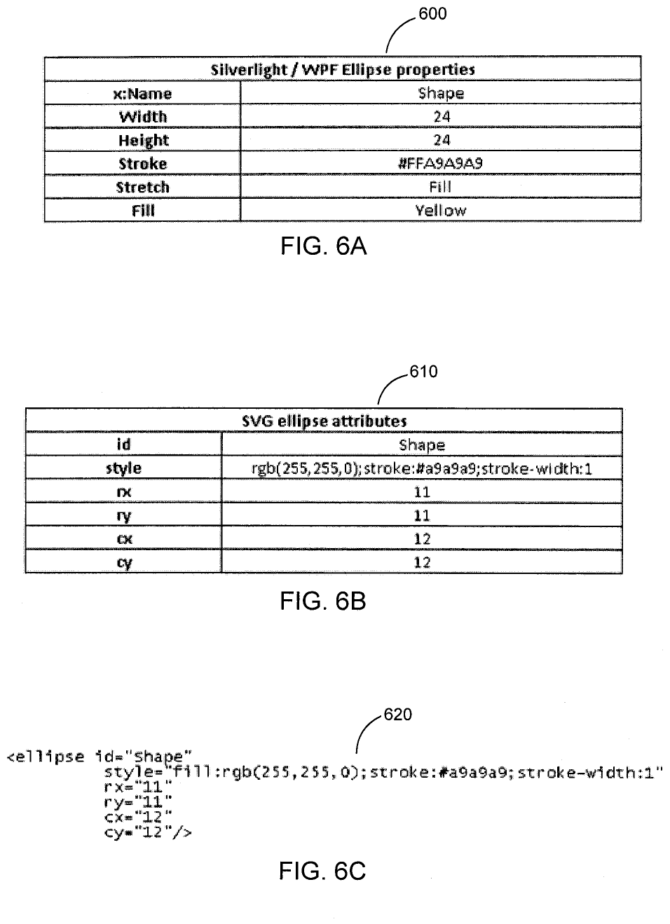

FIGS. 6A-6C are charts containing exemplary data illustrating the conversion of an ellipse object (as may be stored in the first dashboard image data 116) into the second dashboard image data 116′ for incorporation into and display in the dashboard web page 140. Referring now to FIG. 6A, illustrated therein is a table showing the properties (i.e., property names and values) of an example Silverlight/WPF “Ellipse” object shown generally as 600 which may exist in the WPF object tree 504 in FIG. 5.

Turning now to FIG. 6B, this is a table illustrating example SVG “ellipse” attributes 610 (i.e., attribute names and values) corresponding to the Silverlight/WPF object 600 after conversion using the converter 308 in FIG. 5.

FIG. 6C is a schematic illustration of an example SVG ellipse markup tag 620 corresponding to the SVG ellipse attributes 610 shown in FIG. 6B.

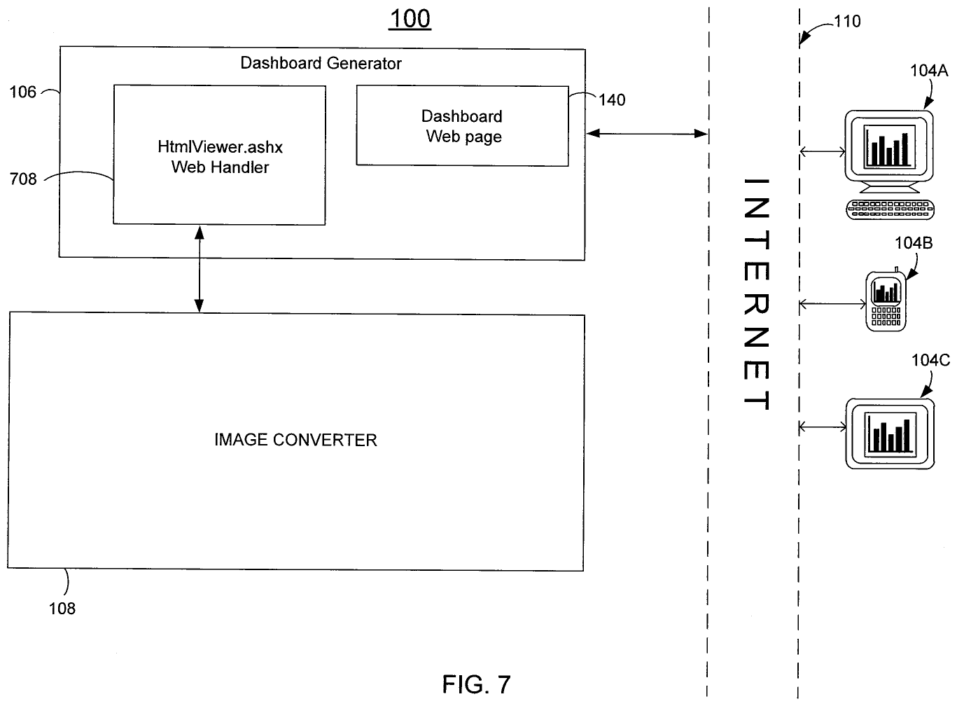

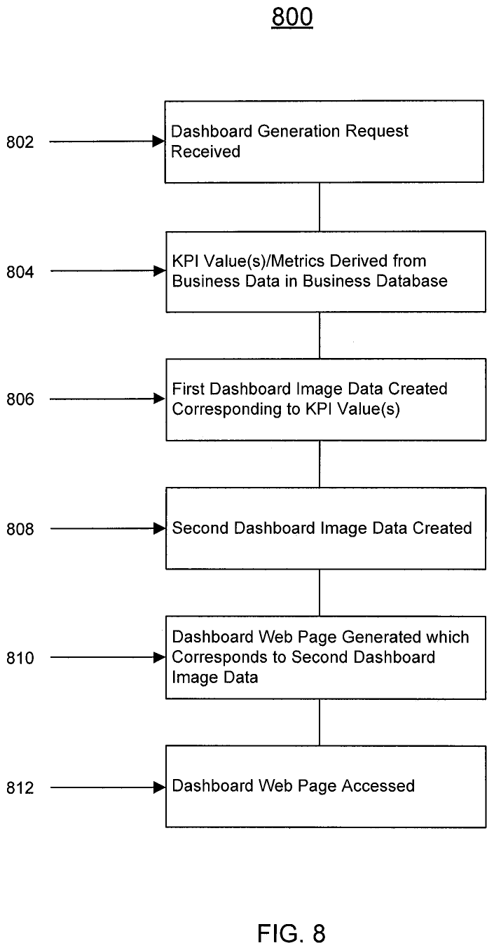

Referring simultaneously to FIGS. 7 and 8, exemplary methodology and component configuration are discussed. FIG. 7 provides some additional detail of the dashboard generator 106 and the image converter 108 and their interaction with other components of the system 100 as may be implemented in accordance with the present disclosure. FIG. 8 is a flow diagram of a method, shown generally as 800, for generating a dashboard for access on a remote computing device, in accordance with one or more possible embodiments.

The “on-demand” generation of a dashboard 200 for viewing remotely may be initiated by a computer, such as a remote computing device 104A, 104B, 104C navigating to the HtmlViewer.ashx URL/web handler 708 (which may be hosted by, and forms part of, the dashboard generator 106) at the corresponding URL in order to generate a request to generate a specific dashboard 200. A dashboard generation request is received by the dashboard generation module 106 from the remote computing device 104A, 104B, 104C accessing the dashboard image web page 140. (Block 802)

As noted above, various parameters defining the type of data and the display preferences of the dashboard 200 may be specified within the dashboard URL 150 corresponding to the dashboard web page 140. Such parameters may be communicated to the generation module 106 via URL query parameters. By way of further example, such parameters may include the information needed to identify the dashboard, such as its GUID (Globally Unique Identifier) and the state of its filters (if any), which are passed in to the web page 140. An example URL comprising such parameters contained within the URL might look like the following: “http://dashsvr/HtmlViewer.ashx?param1=xx&param2=yy& . . . ”, with “xx” and “yy” representing dummy values for exemplary parameters represented by “param1” and “param2”, respectively.

Upon receiving the query parameters necessary to identify and/or generate the desired dashboard 200, the dashboard generation module 106 is configured to access the business database 112 and derive one or more KPI/metric values from the business data 120. (Block 804)

The dashboard generation module 106 may generate the first dashboard image data 116 corresponding to the desired dashboard 200 (which in turn corresponds to the one or more KPI values). (Block 806) As has previously been discussed, the first dashboard image data 116 corresponds to a graphics platform format (such as Silverlight and/or WPF).

The web handler 708 may then cause the image converter 108 to create second dashboard image data 116′ corresponding to the first dashboard image data 116. (Block 808) Such conversion process is discussed in greater detail in relation to FIGS. 3, 4, 5 and 6A-6C.

The web page 140 incorporates the second dashboard image data 116′ inline for display of the dashboard 200. (Block 810) This allows the requesting device, such as a remote computing device 104A, 104B, 104C, to access the dashboard web page 140 and view (and interact with) the dashboard 200 in a web browser. (Block 812)

As will be understood, in some embodiments remote computing device(s) 104A, 104B, 104C may navigate to an HtmlExplorer.ashx web handler URL which is configured to present a user interface for browsing and selecting an available dashboard for HTML viewing. In such embodiments, there is no need to pass in URL query parameter(s) such as a dashboard ID because the dashboard parameter(s) may be chosen interactively.

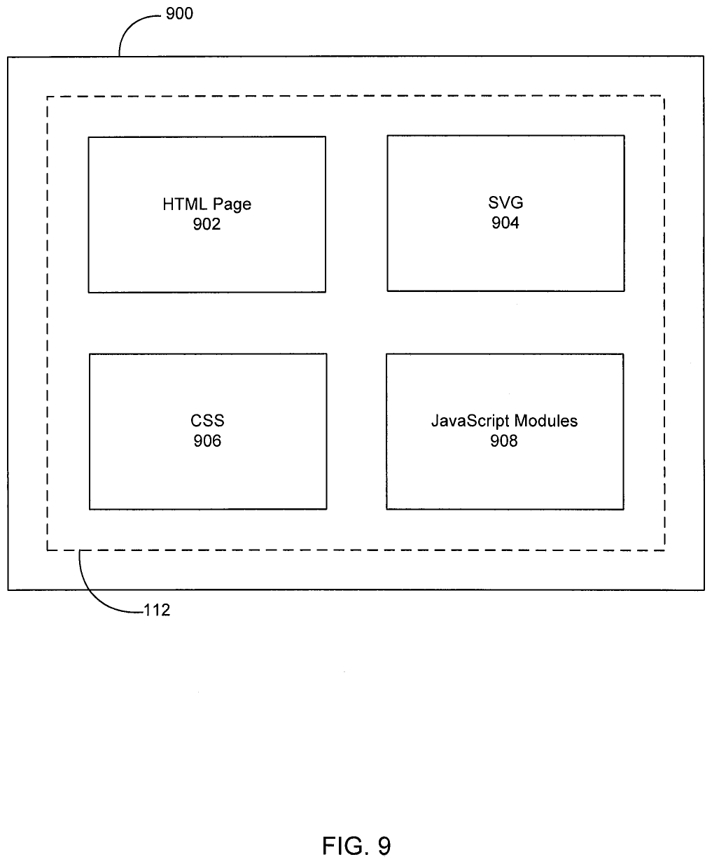

Turning briefly to FIG. 9, illustrated therein is a schematic diagram illustrating the structure, shown generally as 900, of the HTML content (of the second dashboard image data 116′) representing a dashboard 200. In the context of FIG. 9, “HTML content” is intended to refer to HTML/HTML5, SVG, CSS, JavaScript collectively. As will be understood, SVG, CSS, and JavaScript are all standards which are different from the HTML standard. The HTML content 900 includes HTML page data 902, SVG data 904, CSS data 906 and JavaScript modules 908. The CSS elements/data 906 may provide styling for the HTML elements/data 902 and SVG elements/data 904.

The JavaScript modules/files 908 may provide a framework for making the “HTML dashboard” interactive. This includes handling events from the web browser (mouse, touch) and providing implementation of JavaScript-only controls such as datagrid, datepicker, slider, dropdownlist and a hierarchy explorer.

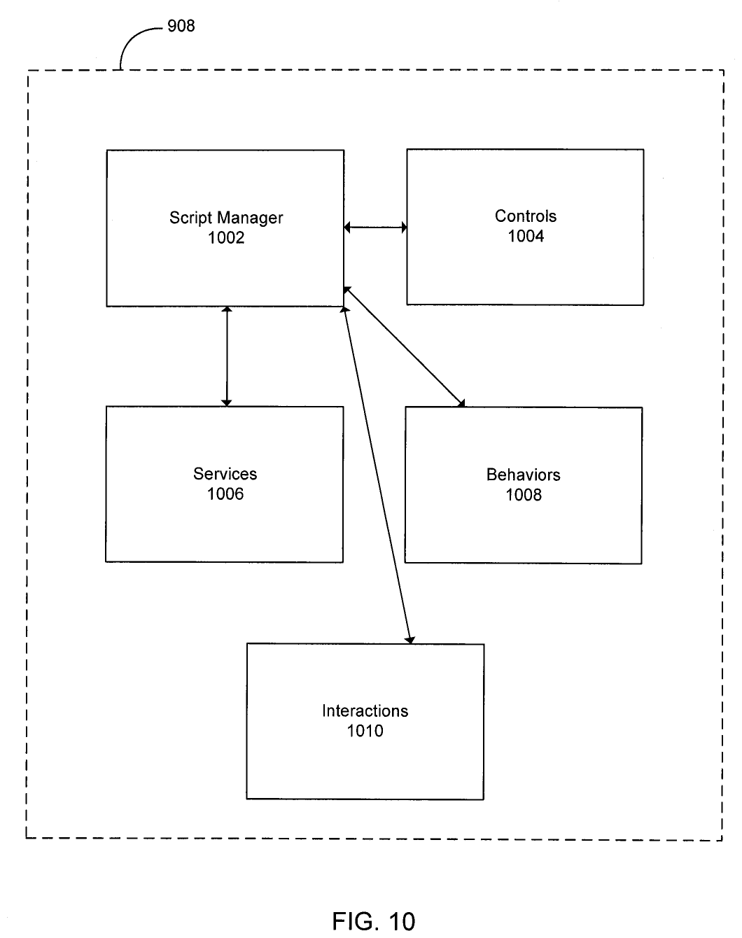

Referring now to FIG. 10, illustrated therein is a schematic diagram illustrating the various types of modules comprising the JavaScript framework 908 which follows a component service type of architecture. As illustrated, the JavaScript modules 908 may include a script manager 1002, controls 1004, services 1006, behaviors 1008 and interactions 1010.

The script manager 1002 is a singleton class which controls the whole page and is responsible for setting up the client side framework. Controls 1004 are script classes which are attached to browser DOM (Document Object Model) elements. Their purpose is to use JavaScript and the browser's DOM to add interactivity to their target elements and perform computations. For example: the datepicker control class recalculates its calendar as the user selects various years, months, and days. Controls 1004 have access to the script manager 1002 and can use it to make AJAX requests to the server (e.g., AJAX request to HtmlViewer.ashx 708). For example, if you click a dropdownlist that is used to filter data appearing on the dashboard, the new selection must be sent back to the server (via AJAX request) so that it can render the updated dashboard, convert it, and send back the updated HTML content.

The services 1006 provide common functionality that can be accessed by anything on the web page 140 (shared services).

Behaviors 1008 represent the logic behind a complex event which has no native browser equivalent. For example: a hover behavior represents the sequence of events of the mouse entering an element, moving within it and becoming stationary for a set period of time. This logic is abstracted and made reusable by packaging it into a behavior. Script controls instantiate a hover behavior and listen for its ‘hover’ event. When and where the ‘hover’ event fires is abstracted by the behavior. When on touch browsers, the hover behavior can use different logic for determining what constitutes a hover without affecting the script controls.

Interactions 1010 are components that can be attached to DOM (Document Object Model) elements to respond to common dashboard interaction events (eg: click, hover). Interactions allow for handling of client-side events on any DOM element without having to define a script control for it. This saves development effort since script control classes do not have to be defined for static dashboard elements (e.g., Label) which have no client-side functionality besides responding to common events.

Dashboard with 1 chart and 1 dropdown list filter:

The following outlines an exemplary sequence as may be carried out via the web browser of a remote computing device(s) 104A, 104B, 104C when accessing the dashboard web page 140 for a dashboard 200 having 1 chart and 1 dropdown list control which can be used to filter data appearing on the dashboard 200:
1. The dashboard 200 (specifically, the second dashboard data 116′) is rendered to the browser via the HtmlViewer.ashx handler 708.
2. The Script Manager 1002 is created and registers a handler for the DOMContentLoaded' event.
3. The browser fires the event and the Script Manager 1002 begins its initialization.
4. The Script Manager 1002 creates and initializes the script services.
5. The dashboard web page 140 contains inline JavaScript which hold information about the various script objects which must be created, their initialization parameters, and the DOM elements to which they should be attached.
6. The Script Manager 1002 creates and initializes each script object.
7. The onLoaded method is invoked for each object permitting it to initialize itself.
8. Once all objects have been created, the dashboard web page 140 is ready for use.
9. The user may select a value from the dropdown list control.
10. The ‘change’ event handler for the dropdown list script control 1004 class is invoked.
11. The script control 1004 gets the selected value and uses the Script Manager 1002 to trigger an AJAX (Asynchronous JavaScript and XML) call to update the dashboard 200.
12. The Script Manager 1002 invokes the AJAX request. If the Script Manager 1002 has any server state information saved, it is sent along with the request.
13. The HtmlViewer.ashx handler 708 processes the request and renders a JSON (JavaScript Object Notation) response with the updated controls and script objects.
14. The Script Manager's 1002 request complete handler is invoked.
15. The Script Manager 1002 checks for any errors during the request and if none are found, begins the process of updating the dashboard 200.
16. The controls 1004 which have been marked as updated by the server's response are overwritten with the updated markup. Any existing script objects bound to the controls 1004 are destroyed.
17. Any new script objects received from the server's response are created and bound to the updated controls 1004.
18. The Script Manager 1002 stores any server state information received from the server.
19. The dashboard 200 is updated and ready for use.

Dashboard with 1 chart and supports drilldown to another dashboard:

The following outlines an exemplary sequence as may be carried out via the web browser of a remote computing device(s) 104A, 104B, 104C when accessing the dashboard web page 140 for a dashboard 200 having 1 chart and which supports a “drill down” to another dashboard 200:
1. The Script Manager 1002 is initialized as in the steps outlined above (for a dashboard 200 having 1 chart and 1 dropdown list control).
2. User “clicks” on the chart.
3. The chart does not have an associated script control but instead has a click interaction.
4. The click interaction registers the click and uses the ScriptManager to trigger an AJAX call to update the dashboard 200.
5. The Script Manager 1002 invokes the request.
6. The request is processed on the server as outlined above.
7. The server's response indicates that methods from the ScriptServices service should be invoked.
8. The Script Manager 1002 retrieves the ScriptManager service and tells it to invoke the methods.
9. The NavigateToDashboard ScriptService method is invoked with associated parameters.
10. The method creates a new URL to the dashboard with the given ID and with the given parameters.
11. The method sets the window.location property to the new URL.
12. The browser navigates to the new web page 140.
13. The HtmlViewer.ashx handler 708 renders the new dashboard 200 (which may be the same as the previous one) with the given parameters thus creating a drilldown.
14. The new dashboard 200 is ready for viewing and interaction.

Mouse versus touch event handling

Client devices such as smartphones may support only touch events natively. However, most websites have no concept of touch events and are designed to respond to mouse events only. Thus, web browsers on touch devices generally implement a compatibility/legacy layer that emulates mouse events. For example, when a user touches their smartphone screen, the touch browser fires a TouchStart event. When the user releases their touch, a TouchEnd event is fired. The compatibility layer kicks in a short time after (possibly up to 500 milliseconds later) and fires off corresponding, emulated (fake) mouse events. This allows new touch devices to work with existing websites, albeit with a bit of a delay/lag.

This approach may result in three general types of disadvantage. First, a lag or delay may occur on the touch device which makes the website appear less responsive. Second, a noticeable flashing/highlighting effect may result. For example, on a touch device with certain browser (such as Safari) and the user tap's on something on the touch display, the browser may create a partially transparent rectangle over what was tapped and flashes it if the web page is configured to receive mouse events only (i.e. the browser flashes the target element to indicate a click). The flashing can be removed via CSS, but this is just masking the problem. Third, emulated mouse events can only have one point, whereas touch events can give you multiple simultaneous touches (multi-touch events) and support for gestures like swipe.

To solve the above problems (which happen when a website is configured to receive mouse events only), it is necessary to determine if the browser is configured for touch events or mouse events. However, it is not possible to determine this with absolute certainty. One approach (when designing a new website for both desktops and mobile) is to use browser detection in the JavaScript code. Such browser detection checks the userAgent or uses feature detection on browser objects.

Detection based on the userAgent is prone to inaccuracies. For example: Windows Phone uses IE (Internet Explorer) 9 with touch events, whereas regular IE 9 works with mouse events, but the userAgent would report both as IE 9. Another example is Google Chrome which can switch to touch mode if its environment is touch-based (eg. a Windows desktop that has a touchscreen). Such browser detection is also not future proof (e.g., every time a new browser is released, it may be necessary to update the existing detection code).

Another approach is to configure the website to always handle both touch and mouse events. By handling both, the lag problem may be resolved but the flashing problem may not be. The flashing occurs wherever a mouse event is attached, regardless of whether the mouse event “fires” or not. This is because the browser detects that a mouse event handler is registered, and so it will go through its mouse compatibility/legacy pipeline.

The solution used in the present disclosure is to determine if the browser is configured for touch events or mouse events based on which type of event is received first in the web page 140. Then either touch or mouse event handlers (based on which type of event is received first) are registered (but not both). This approach works because if the user is accessing the web page 140 via a touch device, touch events always arrive first. Thus only one type of event (mouse or touch) is triggered by the browser, and not both. A corresponding event (or layer) is not triggered. The solution does not care about which type of browser is being used.

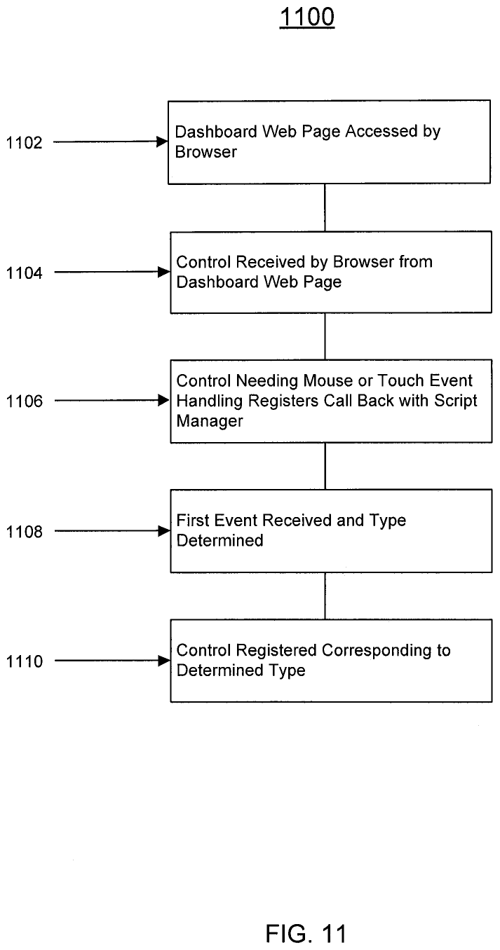

As further illustrated in FIG. 11, the following outlines an exemplary sequence shown generally as 1100 for determining whether the browser is configured for touch events or mouse events as may be carried out by a remote computing device(s) 104A, 104B, 104C when accessing the dashboard web page 140 for a dashboard 200:
1. The dashboard web page 140 (which incorporates Script Manager 1002 and control data) is accessed by the browser of a remote computing device(s) 104A, 104B, 104C. (Block 1102)
2. The Script Manager 1002 and control data are received by the web browser from the web page 140. The web page 140 initiates an onload event which starts up the Script Manager 1002 (running on the web browser). The Script Manager 1002 is responsible for setting everything up such as creating JavaScript controls 1004 corresponding to the received control data. (Block 1104)
3. If a created control 1004 needs to hook mouse/touch events, the control delays its event registration and instead registers a callback with the script manager 1002. (Block 1106)
4. As will be understood, the system waits for the user to interact with the web page 140. When the first event is received by the page 140 as a result of user interaction (e.g., the user moves the mouse or touches a touchscreen), the Script Manager 1002 checks the type of the event (ie. touch or mouse event) and sets its own IsTouchBrowser boolean (ie. “yes” or “no”) value. (Block 1108) The Script Manager 1002 then notifies each of the controls 1004 that registered a callback and causes each such control 1004 to register or configure itself for either mouse or touch operation (corresponding to the first detected event). (Block 1110)

It will be understood that while the term databases are illustrated and used in the present disclosure, any suitable method of persistent storage (e.g., a fixed format file system) may be used in the role of the illustrated databases. It will also be understood by a person skilled in the art that data and/or databases illustrated and/or described separately herein can be stored together as separate files or data elements within the same or multiple databases both locally and/or remotely.

It will also be understood that other system arrangements and configurations may be possible. It will be understood by persons skilled in the art that variations are possible in variant implementations and embodiments. Such variations include, but are not limited to, variations in the connectivity amongst described components, the sequence of execution by described components and the organization of described components.

The steps of a method in accordance with any of the embodiments described herein may be provided as executable software instructions stored on computer-readable media, which may include transmission-type media. Such steps may not be required to be performed in any particular order, whether or not such steps are described in claims or otherwise in numbered or lettered paragraphs.

The invention has been described with regard to a number of embodiments. However, it will be understood by persons skilled in the art that other variants and modifications may be made without departing from the scope of the invention as defined in the claims appended hereto.

1.-21. (canceled)

22. A method for generating a dashboard for access on a remote computing device, the method comprising:
receiving a dashboard generation request from the remote computing device, the dashboard generation request comprising:
a globally unique identifier for the requested dashboard, and
a state of at least one filter for the requested dashboard;
deriving, based on the globally unique identifier and the state of at least one filter, a plurality of key performance indicator or metric values from a business database;
determining first dashboard image data corresponding to the key performance indicator or metric values, the first dashboard image data comprising a serialized definition of the requested dashboard and graphical controls in a first format;
determining, from the first dashboard image data, second dashboard image data corresponding to the first dashboard image data, the second dashboard image data being in a second format;
generating a dashboard web page for display on the remote computing device, the dashboard web page comprising the second dashboard image data.

23. The method of claim 22, wherein the dashboard web page is accessed by the remote computing device.

24. The method of claim 22, wherein the dashboard generation request is communicated via the Internet.

25. The method of claim 22, wherein the first dashboard image data corresponds to a graphics platform.

26. The method of claim 22, wherein the first dashboard image data comprises at least one graphical object.

27. The method of claim 22, wherein the second dashboard image data corresponds to a web browser format.

28. A method for generating interactive and scalable dashboards on a server computer for concurrent access on a first client device and a second client device, the method comprising:
receiving a first dashboard generation request from the first client device, wherein the first dashboard generation request comprises a globally unique identifier for the requested first dashboard and a state of at least one filter for the requested first dashboard, and wherein the first client device comprises a first web browser that supports an interactive and scalable graphics platform;
deriving a first plurality of key performance indicator or metric values from a business database upon receiving the first dashboard generation request;
determining first dashboard data corresponding to the key performance indicator or metric values corresponding to the first dashboard generation request, wherein the first dashboard data comprises serialized definitions of the requested dashboard and first graphical controls;
deserializing the first dashboard data into first in-memory dashboard objects;
data-binding the first in-memory dashboard objects and generating first dashboard image data that corresponds to the first dashboard data and comprises first graphics data that can be displayed in the first web browser;
generating an interactive web page comprising the first dashboard image data for display in a web browser that supports the graphics platform on the first client device;
receiving a second dashboard generation request from the second client device, wherein the second dashboard generation request comprises a globally unique identifier for the requested second dashboard and a state of at least one filter for the requested second dashboard, and wherein the second client device comprises a second web browser that does not support the graphics platform;
deriving a second plurality of key performance indicator or metric values from a business database upon receiving the second dashboard generation request;
determining second dashboard data corresponding to the key performance indicator or metric values corresponding to the second dashboard generation request, wherein the second dashboard data comprises serialized definitions of the requested second dashboard and second graphical controls;
deserializing the second dashboard data into second in-memory dashboard objects;
generating scalable vector graphic elements from the second in-memory dashboard objects, wherein the scalable vector graphic elements correspond to the second dashboard data and can be displayed in the second web browser;
generating an interactive web page comprising the scalable vector graphic elements for display in the second web browser on the second client device.

29. The method of claim 28, wherein the globally unique identifier for the requested first dashboard and the state of at least one filter for the requested first dashboard are the same as the globally unique identifier for the requested second dashboard and the state of at least one filter for the requested second dashboard.

30. A system comprising a processor and a memory, the processor configured to execute instructions of one or more application modules, the execution of the one or more application modules causing the processor to:
receive a first dashboard generation request from a first client device, the first dashboard generation request comprising a globally unique identifier for the requested first dashboard and a state of at least one filter for the requested first dashboard, the first client device comprising a first web browser that supports an interactive and scalable graphics platform;
derive a first plurality of key performance indicator or metric values from a business database in response to receiving the first dashboard generation request;
determine first dashboard data corresponding to the key performance indicator or metric values corresponding to the first dashboard generation request, the first dashboard data comprising serialized definitions of the requested dashboard and first graphical controls;
deserialize the first dashboard data into first in-memory dashboard objects;
data-bind the first in-memory dashboard objects and generate first dashboard image data that corresponds to the first dashboard data and comprises first graphics data that can be displayed in the first web browser;
generate an interactive web page comprising the first dashboard image data for display in the first web browser on the first client device;
receive a second dashboard generation request from a second client device, the second dashboard generation request comprising a globally unique identifier for the requested second dashboard and a state of at least one filter for the requested second dashboard, the second client device comprising a second web browser that does not support the graphics platform;
derive a second plurality of key performance indicator or metric values from a business database upon receiving the second dashboard generation request;
determine second dashboard data corresponding to the key performance indicator or metric values corresponding to the second dashboard generation request, wherein the second dashboard data comprises serialized definitions of the requested second dashboard and second graphical controls;
deserialize the second dashboard data into second in-memory dashboard objects;
generate scalable vector graphic elements from the second in-memory dashboard objects, wherein the scalable vector graphic elements correspond to the second dashboard data and can be displayed in the second web browser; and
generate an interactive web page comprising the scalable vector graphic elements for display in the second web browser on the second client device.
